(19) United States
(12) Patent Application Publication
(10) Pub. No.: US 2004/0247497 A1
(43) Pub. Date: Dec. 9, 2004

(54) Vehicular photoelectron air purifier

(76) Inventor: Se Kit Yuen, Hong Kong (CN)

Correspondence Address: SUGHRUE MION, PLLC, 2100 PENNSYLVANIA AVENUE, N.W., SUITE 800, WASHINGTON, DC, 20037, US

(21) Appl. No.: 10/861,421

(22) Filed: Jun. 7, 2004

(30) Foreign Application Priority Data
Jun. 6, 2003 (CN) 03262307.0
Jun. 6, 2003 (CN) 03262308.9

(51) Int. Cl. B01J 19/08; B01J 19/12

(52) U.S. Cl. 422/186.3

(57) ABSTRACT

This invention relates to a vehicular photoelectron air purifier, and its body is a square-columnar structure and in which comprises: extractor fan, transformer, circuit board, and polarization end ultraviolet ray radiation tube. The said body is equipped with one air inlet and one air outlet; the air outlet locates at the front of the body and an air exhaust frame trellis device is provided on the plane of the front end surface of the body; the air inlet locates at the rear of the body and an air intake frame trellis device is provided at the rear end of the body; the intake frame trellis device provides an air inlet that is used for fixing dustproof frame, dustproof net and dustproof cover; the extractor fan is kept close to the inner surface of the air exhaust frame trellis device; there is an air collector between the air inlet and the extractor fan; the polarization end ultraviolet ray radiation tube lies in the center of the air collector. Because of the outstanding effect of the ultraviolet ray killing virus, bacillus and mildew, the air, under the action of the extractor fan, is forced to pass through around the ultraviolet light tube for the purpose of killing virus, bacillus and mildew; because two extractor fans are arranged abreast along the linear direction of the polarization end ultraviolet ray tube, the air flow increases in amount and the treating capacity strengthens so as to sufficiently kill virus, bacillus and mildew contained in the air.

### TECHNICAL FIELD

The present invention relates to a vehicular photoelectron air purifier, which is used for killing virus, bacillus and mildew etc. in the air through purifying the air by the polarization end ultraviolet ray, and which can be powered by the vehicular power supply besides the municipal power supply.

### TECHNICAL BACKGROUND

Insufficient ventilation indoor or close room readily makes the air dreggy and leads to the virus and bacillus propagated and spread. In the public and the air conditioning room, therefore, it is necessary to manually purify the air and kill virus and bacillus without delay for keeping fresh air in room. In the air conditioning room in summer, purification of indoor air is also a very important problem that is difficult to be solved. More and more attentions are drawn to the air purification indoor because of wide diffusion of the SARS virus. In the conventional method, the ultraviolet light for killing bacillus may cause injure by irradiating the human body. In addition, the present conventional ventilating and air conditioning equipment have no air purifying function, which generally are equipped with simple dedusting and filtering devices, and it will need high cost if it is to be replaced. In addition to the indoor air being required purifying, special needs are given to purify without delay the air in car, train, airplane and ship department.

### SUMMARY OF INVENTION

The object of this invention is to overcome the defects in the prior art, and to provide vehicular photoelectron air purifier, which is used for purifying the air with high efficiency through the ultraviolet or through such way as combing the ultraviolet and the negative ion. During the design of the purifier and the deployment of the power supply, the usage in the vehicles such as car and ship is taken into account.

The object of this invention is realized by the following technical scheme.

According to one aspect of the invention, a vehicular photoelectron air purifier is provided,the body of which is a square-columnar structure, in which comprising: extractor fan, transformer, circuit board, and polarization end ultraviolet ray radiation tube. It is characterized that the said body is equipped with one air inlet and one air outlet; the air outlet locates at the front of the body and the air exhaust frame trellis device is provided on the plane of the front end surface of the body; the air inlet locates at the rear of the body and the air intake frame trellis device is provided at the rear end of the body; the intake frame trellis device provides an air inlet and is used as a fixed dustproof frame, dustproof net and dustproof cover; the extractor fan is kept close to the inner surface of the air exhaust frame trellis device; there is an air collector between the air inlet and the extractor fan; the polarization end ultraviolet ray radiation tube lies in the center of the air collector.

According to another aspect of the present invention, a vehicular photoelectron air purifier is provided, the body of which is a square-columnar structure, in which comprising: extractor fan, transformer, circuit board, polarization end ultraviolet ray radiation tube, and cathodal high-voltage discharging carbonized fiber wire, it is characterized that the said body is equipped with one air inlet and one air outlet; the air exhaust frame trellis device with cambered surface structure is provided on the rear upper part of the body; the outer frame trellis device is provided at the front of the body; the air intake frame trellis device is provided at the rear of the outer frame trellis device; the intake frame trellis device provides an air inlet and is used as a fixed dustproof frame, dustproof net and dustproof cover; the cathodal high-voltage discharging carbonized fiber wire is fixed in the center of the front surface of the air exhaust frame trellis device; the polarization end ultraviolet ray radiation tube is mounted at the air outlet in the body and lies in the air collector; the extractor fan and an electric motor are kept close to the inner surface of the air intake frame trellis device.

One advantage of this invention is as follows: since the ultraviolet has outstanding effect for killing virus, bacillus and mildew, the air, under the action of the extractor fan, is forced to pass through around the ultraviolet light tube for the purpose of killing virus, bacillus and mildew; because there are two extractor fans arranged abreast along the linear direction of the polarization end ultraviolet ray tube, the air flow increases in amount and the treating capacity strengthens so as to sufficiently kill virus, bacillus and mildew in the air.

Another advantage of this invention is that this vehicular photoelectron air purifier use the polarization end ultraviolet ray to kill virus, bacillus and mildew in air; meanwhile, the cathodal high-voltage discharging carbonized fiber wire can be used for increasing negative ions in the environment; when the air is drawn into the purifier by the fan, two continuously alternating working modes are available, i.e., both the ultraviolet radiation and the high voltage ionization negative ion are automatically and alternatively operated so as to provide ideal air purifying effect; the sheltering wall and the air collector are provided around the polarization end ultraviolet ray radiation tube in the body of the present invention, so the ultraviolet ray shall not irradiate to the outside of the body and thus preventing eye injure of the user from leakage of the ultraviolet; the purifier of the present invention can use both the municipal power supply and the car power supply, so it is convenient for carrying and using and applicable for various places.

### DESCRIPTION OF DRAWINGS

FIG. 1 is a side view of the product according to the first embodiment of this invention.

FIG. 2 is a vertical sectional view of the product shown in FIG. 1.

FIG. 3 is a cross sectional view of the product shown in FIG. 1.

FIG. 4 is a front view of the product shown in FIG. 1.

FIG. 5 is a back view of the product shown in FIG. 1.

FIG. 6 is another side view of the product shown in FIG. 1.

FIG. 7 is a top view of the product shown in FIG. 1.

FIG. 8 is a bottom view of the product shown in FIG. 1.

FIG. 9 is a side view of the product according to the second embodiment of this invention.

FIG. 10 is a sectional view of the product shown in FIG. 9.

FIG. 11 is a front view of the product shown in FIG. 9.

FIG. 12 is a back view of the product shown in FIG. 9.

FIG. 13 is another side view of the product shown in FIG. 9.

FIG. 14 is a top view of the product shown in FIG. 9.

FIG. 15 is a bottom view of the product shown in FIG. 9.

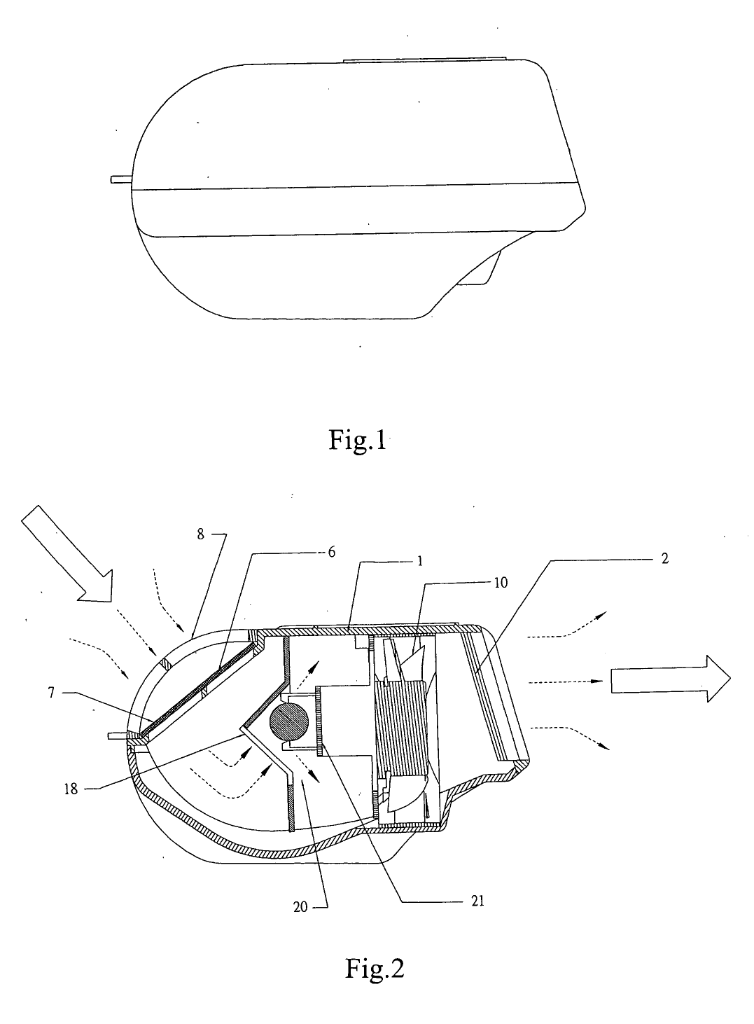

### DESCRIPTION OF THE PREFERRED EMBODIMENTS

The technical scheme of the preferred embodiments of this invention is further explained as follows combined with the attached figures.

The First Preferred Embodiment

The vehicular photoelectron air purifier of the first preferred embodiment of this invention is a horizontal vehicular photoelectron air purifier, which mainly comprising: two rows of extractor fans, polarization end ultraviolet ray radiation tube and air collecting wall. When the air is drawn by the extractor fan into the horizontal vehicular photoelectron air purifier, it will ignite the polarization end ultraviolet ray radiation tube to radiate the polarization end ultraviolet ray which can eliminate virus, bacillus and mildew in the air that flows through the tube. This horizontal vehicular photoelectron air purifier is equipped with one air inlet and one air outlet. The polarization end ultraviolet ray radiation tube is mounted at the said air inlet in the body, while the extractor fan is fixed at the air outlet in the mechanism. When the air containing virus, bacillus and mildew is drawn in the body through the air outlet, the flowing air can easily enter and traverse through the air intake frame trellis device of the portable horizontal vehicular photoelectron air purifier and then reach the air exhaust frame trellis device so that the air containing virus, bacillus and mildew must contact with the polarization end ultraviolet ray radiation tube and thus the polarization end ultraviolet ray eliminates virus, bacillus and mildew contained in the air.

The horizontal vehicular photoelectron air purifier of this invention is light and convenient for user's carrying (a train or car plug is necessary) so that the user can breathe in clean and fresh air free from virus, bacillus and mildew in various places, and thus the respiratory infectious disease can be effectively prevented.

This product has a square-columnar profile. Other features of this invention is described in details in the following aspects:

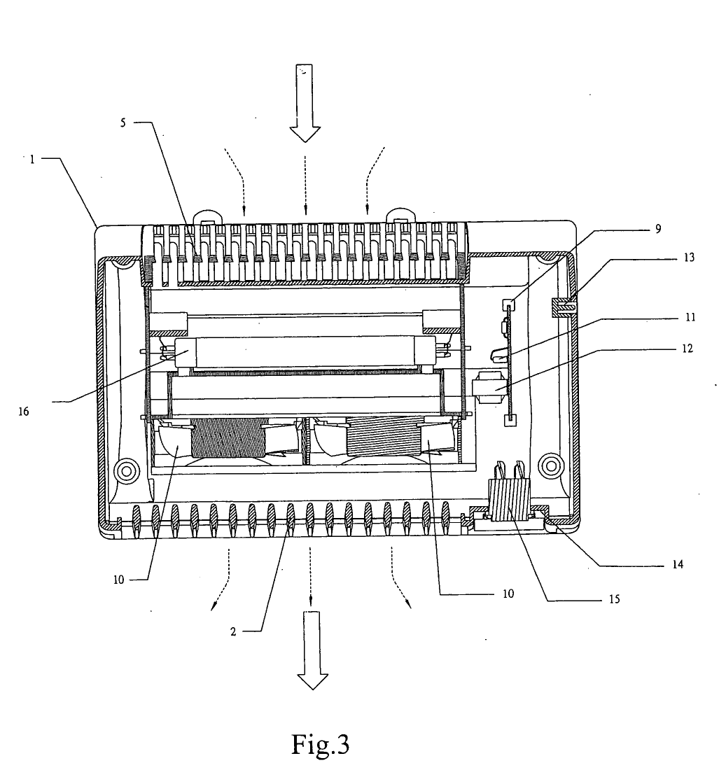

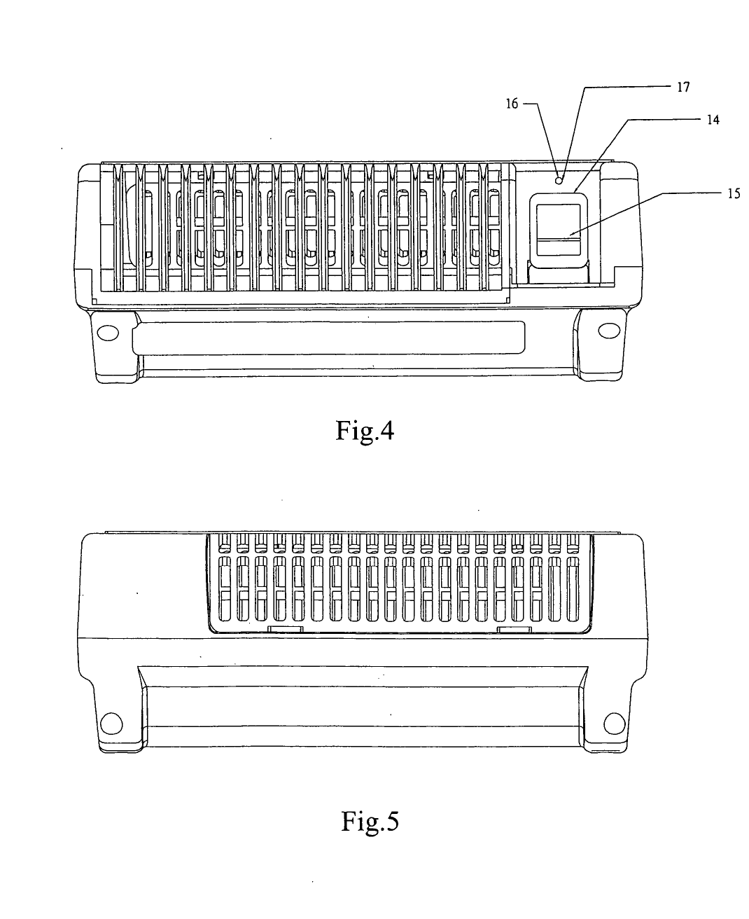

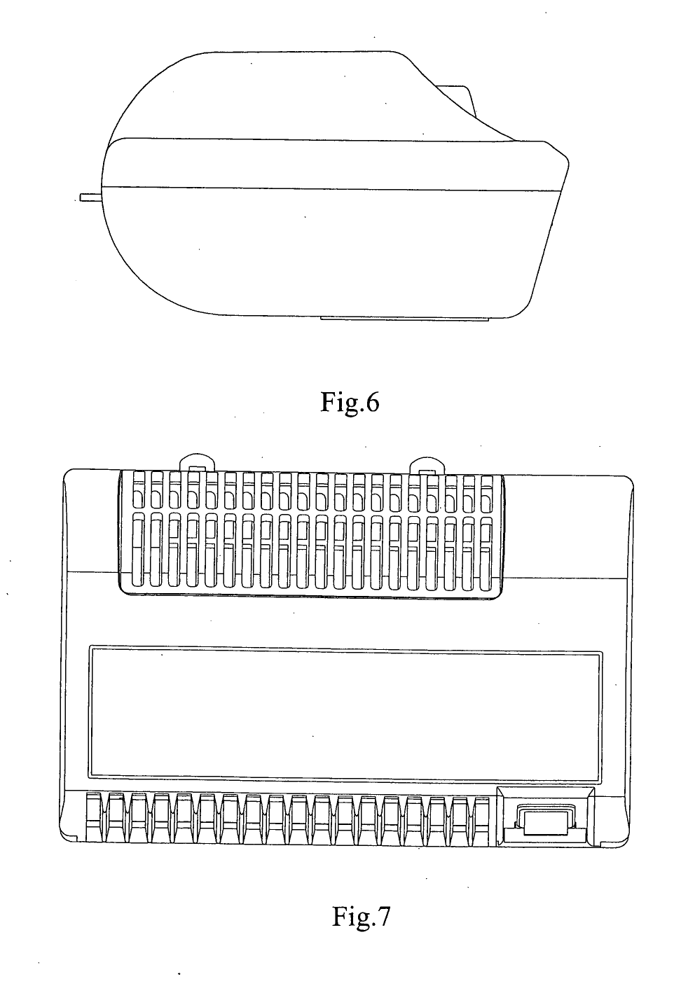

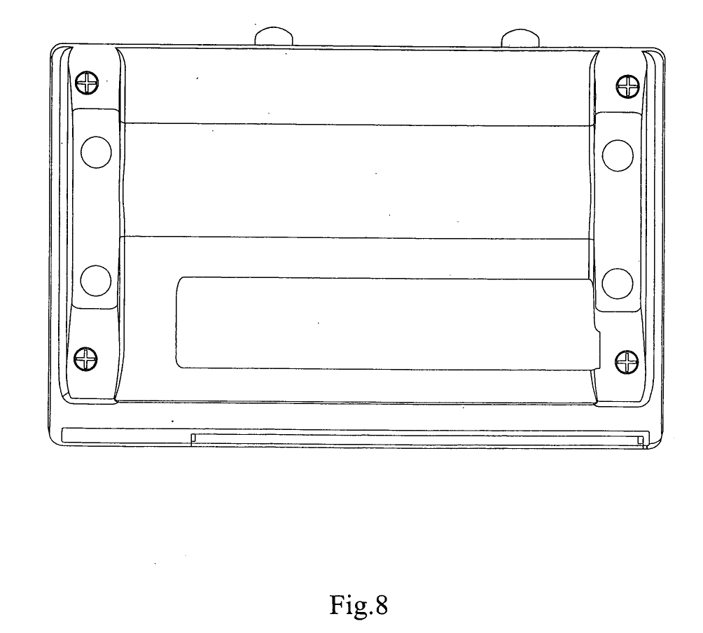

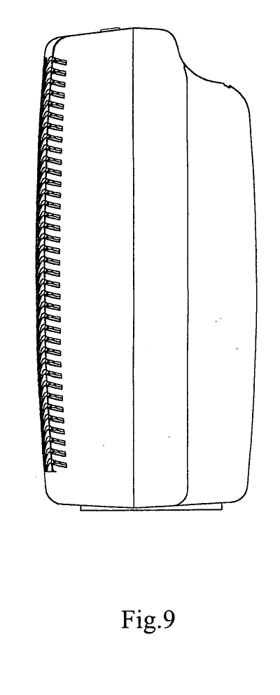

FIG. 2 and FIG. 3 show the detailed structure of the horizontal vehicular photoelectron air purifier. The horizontal vehicular photoelectron air purifier has a body 1 with square-columnar structure, and the air exhaust frame trellis device 2 is provided on the plane of the front end of the body 1; the air with the bacillus killed is exhausted through the air exhaust frame trellis device 2. The air intake frame trellis device 5 is provided at the rear end of the body 1, which provides an air inlet and is used as a fixed dustproof frame 6, dustproof net 7 and dustproof cover 8; an extractor fan 10 is kept close to the inner surface of the air exhaust frame trellis device 2.

An electronic converter 11 is available on the upper part of the support frame 9 which is for protecting and fixing electronic generator of power supply; a power supply socket 13 is provided on the side of the body 1 and provides a connection to the vehicular power supply or the municipal power supply to the user.

A quadrate hole 14 is provided at the front of the body 1 and is used for fixing the switch 15 that is for controlling functions of the extractor fan 10 and the polarization end ultraviolet ray radiation tube 16. There is a hole 16 on the plane above the switch 15, which is used for fixing LBD 17 that is provided for indicating functions.

In the practice, when the horizontal vehicular photoelectron air purifier is operated, the air containing virus, bacillus and mildew is drawn by the extractor fan 10 into the air collecting wall 18 in the body 1 through the dustproof net 7, so the flowing air can easily enter the air collecting wall 18 and then reaches the air exhaust frame trellis device 2. The polarization end ultraviolet ray radiation tube 16 is provided in the center of the air collecting wall 18; this means that when the air containing virus, bacillus and mildew flows and enters the air collectors 18 and 19, and then enter into the air inlet 20 between the polarization end ultraviolet ray radiation tube 16 and the air collecting wall 19, the polarization end ultraviolet ray radiation tube 16 will radiate polarization end ultraviolet ray so as to eliminate virus, bacillus and mildew contained in the air; then the purified clean and fresh air is, by the extractor fan 10, exhausted out of the air exhaust frame trellis device 2.

The sheltering walls 21 are provided at the front and rear of the said air collecting wall 18 for prohibiting user's eyes from injure by the polarization end ultraviolet ray radiating to the outside of the body 1.

The circuit principle of the horizontal vehicular photoelectron air purifier is as follows: the input power is, through the switch 15 and through a full wave band rectifying circuit, supplied to the extractor fan via the speed control circuit, and operate the full wave rectifying circuit of the polarization end ultraviolet ray radiation tube 15 via a DC-AC converting circuit. The structure details of the electronic circuits in this horizontal vehicular photoelectron air purifier belongs to the prior art, therefor it is omitted here.

The Second Preferred Embodiment

The second preferred embodiment of this invention is a vertical vehicular photoelectron air purifier. It uses a polarization end ultraviolet ray radiation tube to radiate the polarization end ultraviolet ray which can eliminate virus, bacillus and mildew contained in the air flowing through the polarization end ultraviolet ray radiation tube, and meanwhile the negative ion in the air can be increased through the operation of the anion machine.

The vertical vehicular photoelectron air purifier of this invention mainly includes: extractor fan, polarization end ultraviolet ray radiation tube and cathodal high-voltage discharging carbonized fiber wire. When the air is drawn into this photoelectron air virus and bacillus killing device, two continuously alternating working modes are available; the first one is intermittent (about 3 to 4 minutes) cathodal high-voltage output discharging via the carbonized fiber, the ionized air produces negative ion and is exhausted through the fan; the other one is intermittent (about 7 to 10 minutes) igniting the polarization end ultraviolet ray radiation tube to radiate the polarization end ultraviolet ray which can eliminate virus, bacillus and mildew in the air that flows through the tube. This photoelectron air purifier is equipped with one air inlet and one air outlet. The cathodal high-voltage discharging fiber wire is mounted at the air outlet, the polarization end ultraviolet ray radiation tube is mounted at the said air inlet in the body, and the fan is fixed at the air outlet in the body. When the air containing virus, bacillus and mildew is drawn into the body through the air outlet, the flowing air can easily enter and traverse through the air intake frame trellis device of the photoelectron air purifier and then reach the air exhaust frame trellis device so that the air containing virus, bacillus and mildew must contact with the polarization end ultraviolet ray radiation tube and thus the polarization end ultraviolet ray eliminates virus, bacillus and mildew contained in the air; then the air is purified by the anion machine, and the clean air containing the negative ion is exhausted out of the air outlet so as to improve the air quality indoor.

This product has a square-columnar structure, with air inlet, extractor fan, polarization end ultraviolet ray radiation tube, and air outlet etc. arranged vertically.

The vertical vehicular photoelectron air purifier comprises the body 1 with a square-columnar structure, the air exhaust frame trellis device 2 with cambered surface structure is provided on rear upper part of the body 1, the outer frame trellis device 4 is provided at the front of the body 1, and the ionized air is exhausted through the air exhaust frame trellis device 2.

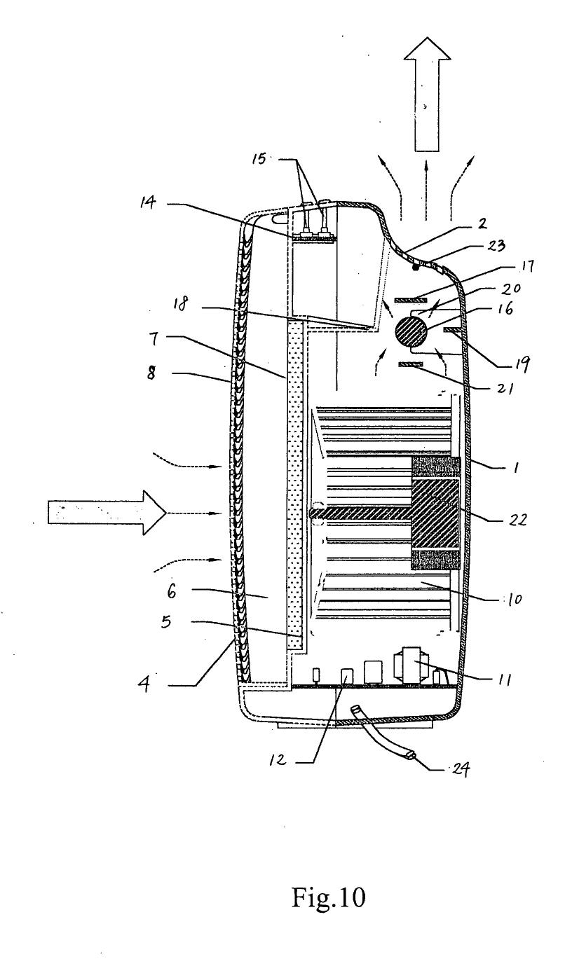

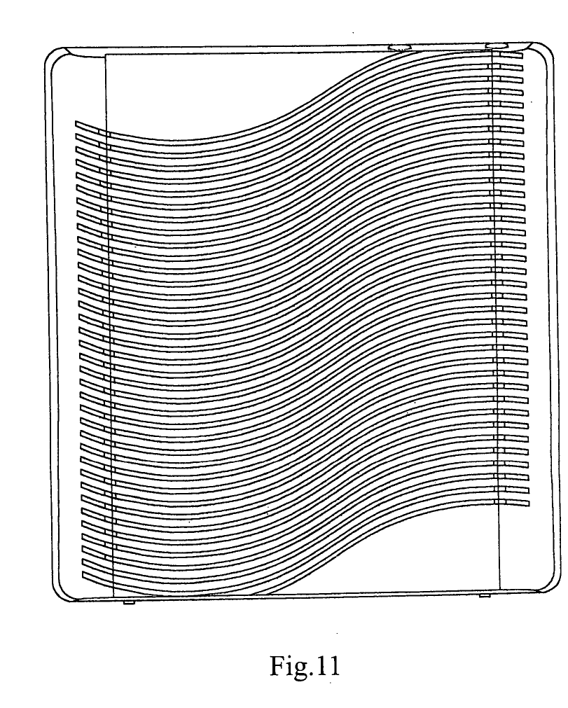

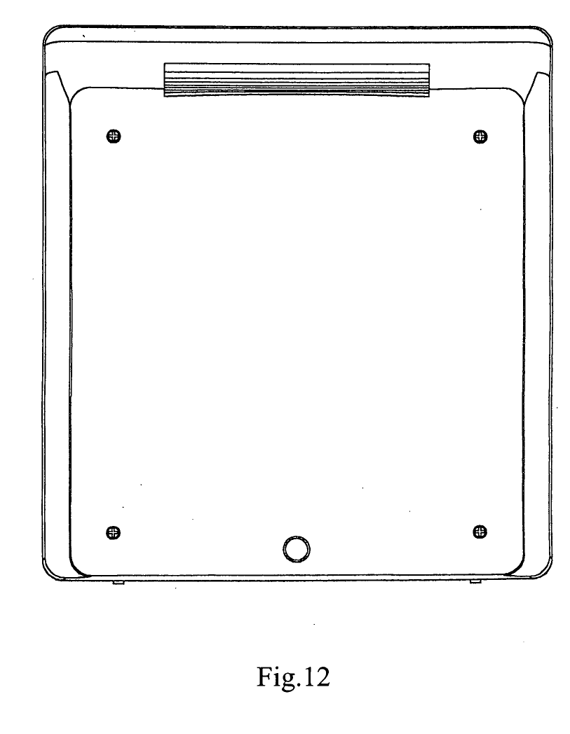

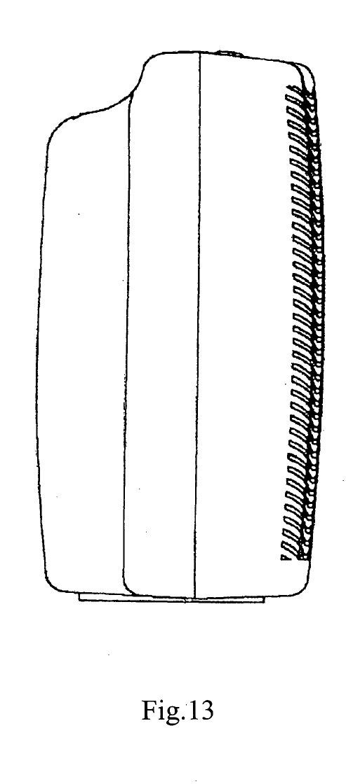

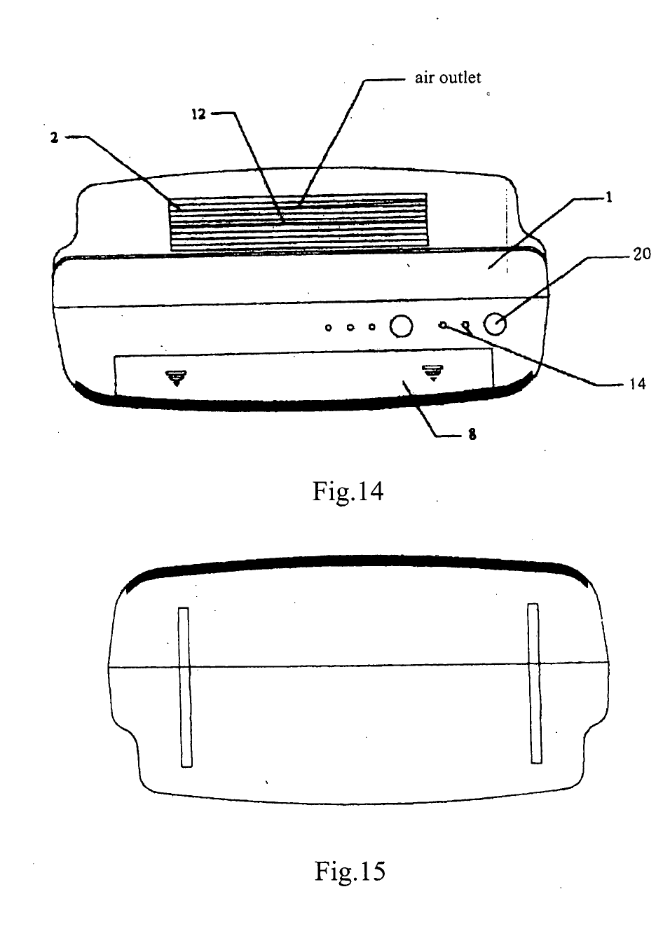

FIG. 10 and FIG. 11 show the detailed structure of the vertical vehicular photoelectron air purifier. The air intake frame trellis device 5 is provided at the front of the body 1, and provides a air inlet and is used as a fixed dustproof frame 6, dustproof net 7 and dustproof cover 8; the extractor fan 10 and a electric motor 22 are kept close to the inner surface of the air intake frame trellis device 5; the carbonized fiber wire 23 is fixed in the center of the front surface of the air exhaust frame trellis device 2 and produces ionized air under the cathodal high voltage.

The positions are available in the body 1 for fixing the electronic generator 12, the electronic converter 11 and the power supply line 24.

A quadrate hole 14 is provided at the upper surface of the body 1 and is used for fixing the switch 15 that is for controlling functions of the electric motor 22, the extractor fan 10, the polarization end ultraviolet ray radiation tube 16 and the carbonized fiber wire 23. There are two holes 14 on the plane above the switch 15, which are used for fixing LBDs 17 with different colors that are provided for indicating functions.

In the practice, when the vertical vehicular photoelectron air purifier is operated, the air containing virus, bacillus and mildew is drawn by the extractor fan 10 into the air collecting wall 18 (behind which there are many long grids) in the body 1 through the dustproof net 7, so the flowing air can easily enter into the air collecting wall 18 and then reaches the air exhaust frame trellis device 2. The polarization end ultraviolet ray radiation tube 16 is provided in the center of the air collecting wall 18; this means that when the air containing virus, bacillus and mildew flows and enters the air collecting walls 18 and 19, and then enters into the air inlet 20 between the polarization end ultraviolet ray radiation tube 16 and the air collecting wall 19, the polarization end ultraviolet ray radiation tube 16 will radiate polarization end ultraviolet ray so as to eliminate virus, bacillus and mildew contained in the air; now the purified air is drawn into the cathodal high-voltage discharging carbonized fiber wire 23 of the air exhaust frame trellis device 2 to produce negative ion, and then the clean air containing the negative ion is exhausted out of the air exhaust frame trellis device 2 so as to improve the air quality indoor.

The sheltering walls 21 are provided at the front and rear of the said air collecting wall 18 and used for prohibiting user's eyes from injure by the polarization end ultraviolet ray radiating to the outside of the body 1.

The circuit principle of the vertical vehicular photoelectron air purifier is as follows: the input power supply is supplied to an anion high-voltage generating circuit through the switch 15, providing a negative high-voltage output. The input power supply is also supplied to the extractor fan 10 via the speed control circuit followed after a full wave band rectifying circuit, and operating the full wave rectifying circuit of the polarization end ultraviolet ray radiation tube 16 via a DC-AC converting circuit. Another input current, via a DC voltage-stabilizing circuit, is supplied to the automatic circulation control circuit of the anion generating circuit and the active circuit of the polarization end ultraviolet ray radiation tube 16 so as to control the alternative operation of the anion generating circuit and the polarization end ultraviolet ray radiation tube 16. The anion high-voltage output of the electronic circuit system is available within a scope of 4.5 kv-8.5 kv. This control circuit belongs to the prior art, the detailed description is omitted here.

The potable photoelectric air virus and bacillus killing machine of this invention uses an polarization end ultraviolet radiation ray tube to produce polarization end ultraviolet ray with wavelength of 253.7 nm. The scientific research proves that such ultraviolet ray can eliminate virus, bacillus and mildew contained in the air most effectively; the negative ion in the air can be increased through the operation of the anion machine so as to facilitate the biochemical action and reduce the secretion of the hormone that makes people feel dumps and fatigue.

The above is only a description over the technical scheme and the preferred embodiments of this invention and not a limitation to the technical scheme of this application. It is obvious that this invention can be realized by many means. The technical person skilled in this art can make various improvements according to the contents and inspirit as specified in the claims of this application.

1. A vehicular photoelectron air purifier, the body of which is in square-columnar structure, in which comprising: extractor fan, transformer, circuit board, and polarization end ultraviolet ray radiation tube, it is characterized that the said body is equipped with one air inlet and one air outlet; the air outlet locates at the front of the body and an air exhaust frame trellis device is provided on the plane of the front end surface of the body; the air inlet locates at the rear of the body and an air intake frame trellis device is provided at the rear end of the body; the intake frame trellis device provides an air inlet and is used as a fixed dustproof frame, dustproof net and dustproof cover; the extractor fan is kept close to the inner surface of the air exhaust frame trellis device; there is an air collector between the air inlet and the extractor fan; the polarization end ultraviolet ray radiation tube lies in the center of the air collector.

2. The vehicular photoelectron air purifier according to claim 1, wherein the said extractor fan arranged in the square-columnar body abreast along the linear direction of the polarization end ultraviolet ray radiation tube is in the number of two

3. The vehicular photoelectron air purifier according to claim 1, wherein the said air collector is composed of a space surrounded by an air collecting wall and a sheltering wall, and the polarization end ultraviolet ray radiation tube is fixed between the front and the rear sheltering walls so that there is no light ray is radiated out of the purifier.

4. The vehicular photoelectron air purifier according to claim 1, wherein a support frame is mounted on the side inside the body, an electronic converter and an electronic generator of power supply are provided at the upper end thereof; a power socket for connecting to the vehicular power supply or the municipal power is provided on the side surface of the body.

5. The vehicular photoelectron air purifier according to any one of the claims 1,2,3 and 4, wherein there is a quadrate hole on the front end surface of the said body, in which a power supply switch for controlling the extractor fan and the polarization end ultraviolet ray radiation tube is arranged; there is a hole on the plane above the quadrate hole, in which a LBD for indicating functions is provided.

6. A vehicular photoelectron air purifier, the body of which is in square-columnar structure, in which comprising extractor fan, transformer, circuit board, polarization end ultraviolet ray radiation tube, and cathodal high-voltage discharging carbonized fiber wire, it is characterized that the said body is equipped with one air inlet and one air outlet; the air exhaust frame trellis device with cambered surface structure is provided on the rear upper part of the body; an outer frame trellis device is provided at the front of the body; the air intake frame trellis device is provided at the rear of the outer frame trellis device; the intake frame trellis device provides an air inlet and is used as a fixed dustproof frame, dustproof net and dustproof cover; the cathodal high-voltage discharging carbonized fiber wire is fixed in the center of the front surface of the air exhaust frame trellis device; the polarization end ultraviolet ray radiation tube is mounted at the air outlet in the body and lies in the air collector; the extractor fan and an electric motor are kept close to the inner surface of the air intake frame trellis device.

7. The vehicular photoelectron air purifier according to claim 6, wherein the said air collector is composed of a space surrounded by an air collecting wall and a sheltering wall, and the polarization end ultraviolet ray radiation tube is fixed between the front and the rear sheltering walls so that there is no light ray is radiated out of the purifier.

8. The vehicular photoelectron air purifier according to claim 6, wherein the electronic converter, the electronic generator of power supply, and the power line are provided at the lower part in the body; a power socket for connecting to the vehicular power supply or the municipal power is provided on the side surface of the body.

9. The vehicular photoelectron air purifier according to any one of the claims 6,7 and 8, wherein there is a quadrate hole on the upper surface of the body, in which a power supply switch for controlling the electric motor, the extractor fan, the polarization end ultraviolet ray radiation tube and the carbonized fiber wire is mounted; there are two holes on the side plane of the said quadrate hole, by which two LBDs with different colors are fixed.
